(19) United States
(12) Patent Application Publication
(10) Pub. No.: US 2008/0307455 A1
(43) Pub. Date: Dec. 11, 2008

(54) System for Providing and Handling Still Video Pictures

(75) Inventor: Peter Praest, Kobenhavn S (DK)

Correspondence Address: Husch Blackwell Sanders, LLP;Welsh & Katz, 120 S RIVERSIDE PLAZA, 22ND FLOOR, CHICAGO, IL, 60606, US

(73) Assignee: NDS Limited, West Drayton, Middlesex (GB)

(21) Appl. No.: 10/580,960

(22) PCT Filed: Mar. 20, 2006
(86) PCT No.: PCT/GB06/00991

§ 371 Date: May 31, 2006

Related U.S. Application Data
(60) Provisional application No. 60/737,610, filed on Nov. 17, 2005.

(51) Int. Cl. G06F 3/00

(52) U.S. Cl. 725/38

(57) ABSTRACT

An interactive television method is disclosed. The method includes receiving, via a broadcast carousel, a photo feed comprising a plurality of still video pictures, sequentially displaying the plurality of still video pictures on a display, enabling a first user to select at least one still video picture from the photo feed, producing a wallet of pictures by storing the at least one selected still video picture, selected by the first user, in a memory, and forwarding the wallet of pictures to a second user. Related apparatus and methods are also disclosed.

### CROSS-REFERENCE TO RELATED APPLICATIONS

The present application claims priority from U.S. Provisional Patent Application Ser. No. 60/737,610, filed 17 Nov. 2005, the disclosure of which is hereby incorporated herein by reference.

### FIELD OF THE INVENTION

The present invention relates generally to interactive television systems.

### BACKGROUND OF THE INVENTION

In television systems, such as satellite television systems, bandwidth is expensive and it is an on-going challenge for content providers to provide content that has sufficient value to justify the bandwidth and costs of content production. Still video pictures (stills) of various types may be considered as content having high value but the stills need to be provided over limited bandwidth in order to be cost effective.

Use of stills in interactive television and multimedia systems is described in the following publications:

U.S. Pat. Nos. 5,903,816 and 5,929,850 to Broadwin et al, which describe a system and method for displaying still video images related to video content in an interactive broadcast television system;

U.S. Pat. No. 5,606,365 to Maurinus et al, which describes a digital still camera and interactive system and method for video display or reproduction of captured images employing an image processing system on an interactive network for receiving and converting a captured raw, digitized image information set into a display image format for display as a video image, storage, and/or reproduction as a print;

Published US Patent Application 20030167469 of Hardingham et al, which describes a method and system of offering for sale images related to a television program via interactive television;

Published US Patent Application 20030038893 of Rajamaki et al, which describes methods and systems for customizing a digital broadcast receiver;

Published US Patent Application 20040117269 of Karaoguz et al, which describes a system providing support for user transactions in a media exchange network;

Published US Patent Application 20040117852 of Karaoguz et al, which describes a system supporting the remote management of options related to media consumption in a media exchange network;

Published PCT Patent Application WO 03/041393 of Creative Frontier Inc., which describes a real time interactive video system;

Published PCT Patent Application WO 99/59339 of Koninklijke Philips Electronics N.V., which describes an interactive television system for selectively retrieving video images or teletext pages from a remote transmitter; and

An article entitled “The Multimedia Home Platform—an overview”, by J.-P. Evain, in EBU Technical Review, Spring 1998.

Some aspects of technologies and related material that may be useful in understanding the present invention are described in the following publications:

U.S. Pat. No. 6,496,981 to Wistendahl et al, which describes a system for converting media content for interactive TV use;

U.S. Pat. Nos. 5,539,450 and 5,592,212 to Handelman, which describe methods and systems for providing additional service applications and non-program applications in pay television;

U.S. Pat. Nos. 5,414,773, 5,715,315 and 6,634,028 to Handelman, which describe a CATV system including a CATV network, a multiplicity of subscriber units, apparatus for transmitting over the CATV network encrypted information individually addressed to a subscriber unit and apparatus associated with each of the multiplicity of subscriber units for decoding the encrypted information addressed thereto; and

Published PCT Patent Application WO 2004/110074 of NDS Limited, which describes a system for transmitting information from a streamed program to external devices and media.

The disclosures of all references mentioned above and throughout the specification, as well as the disclosures of all references mentioned in those references, are hereby incorporated herein by reference.

### SUMMARY OF THE INVENTION

The present invention, in preferred embodiments thereof, seeks to provide a system and method for delivering high value content over limited bandwidth to digital set-top boxes, mobile telephones and Internet client systems while maintaining a “TV-like” user experience through optional interactive features.

In preferred embodiments of the present invention, a photo feed comprising a plurality of still video pictures is transmitted via a broadcast carousel and received at a user's set-top box (STB). The still video pictures are sequentially displayed on a display at the user's site.

Preferably, the user is enabled to select at least one still video picture from the photo feed. The at least one selected still video picture may be stored in a memory and a wallet of pictures may be produced. The user may also forward the at least one selected still video picture, or the entire wallet content, for example to a mobile telephone used by the user or to another user, such as a remote user.

There is thus provided in accordance with a preferred embodiment of the present invention an interactive television method including receiving, via a broadcast carousel, a photo feed including a plurality of still video pictures, sequentially displaying the plurality of still video pictures on a display, enabling a first user to select at least one still video picture from the photo feed, producing a wallet of pictures by storing the at least one selected still video picture, selected by the first user, in a memory, and forwarding the wallet of pictures to a second user.

Preferably, the sequentially displaying includes displaying the plurality of still video pictures starting from a current video picture in a display queue.

The producing preferably includes producing the wallet of pictures in response to receipt of an indication of agreement to pay for the producing.

Preferably, the forwarding includes forwarding the wallet of pictures in response to receipt of an indication of agreement to pay for the forwarding by one of the following: the first user, and the second user.

The photo feed preferably includes at least one targeted advertisement for at least one of the following: the first user, and the second user.

Alternatively or additionally, every one of a predetermined number of still video pictures in the photo feed includes an advertisement. The advertisement is preferably targeted for at least one of the following: the first user, and the second user.

Additionally, the method may also include using a web-interface for storing the wallet content in a large-capacity external memory. The large-capacity external memory preferably includes a web-wallet.

Preferably, the receiving includes tuning to a channel including the photo feed, and the producing includes producing the wallet of pictures for as long as the channel is not changed.

There is also provided in accordance with a preferred embodiment of the present invention a Set-top Box (STB) in an interactive television system, the STB including a receiving unit receiving, via a broadcast carousel, a photo feed including a plurality of still video pictures, and sequentially displaying the plurality of still video pictures on a display, a memory, a processor enabling a first user to select at least one still video picture from the photo feed, and producing a wallet of pictures by storing the at least one selected still video picture, selected by the first user, in the memory, and a transmitting unit forwarding the wallet of pictures to a second user.

Preferably, the receiving unit sequentially displays the plurality of still video pictures on the display starting from a current video picture in a display queue.

The processor preferably produces the wallet of pictures in response to receipt of an indication of agreement to pay for the producing.

Preferably, the transmitting unit forwards the wallet of pictures in response to receipt of an indication of agreement to pay for the forwarding by one of the following: the first user, and the second user.

The photo feed preferably includes at least one targeted advertisement for at least one of the following: the first user, and the second user.

Alternatively or additionally, every one of a predetermined number of still video pictures in the photo feed includes an advertisement. The advertisement is preferably targeted for at least one of the following: the first user, and the second user.

Additionally, the STB may also include a web-interface for enabling storage of the wallet content in a large-capacity external memory. The large-capacity external memory preferably includes a web-wallet.

Preferably, the receiving unit also tunes to a channel including the photo feed, and the processor produces the wallet of pictures for as long as the channel is not changed.

### BRIEF DESCRIPTION OF THE DRAWING

The present invention will be understood and appreciated more fully from the following detailed description, taken in conjunction with the drawings in which:

FIG. 1 is a simplified partly pictorial, partly block diagram illustration of a preferred implementation of an interactive television system for providing and handling still video pictures, the interactive television system being constructed and operative in accordance with a preferred embodiment of the present invention; and

FIG. 2 is a simplified flowchart illustration of a preferred method of operation of a set-top box (STB) in the system of FIG. 1.

### DETAILED DESCRIPTION OF A PREFERRED EMBODIMENT

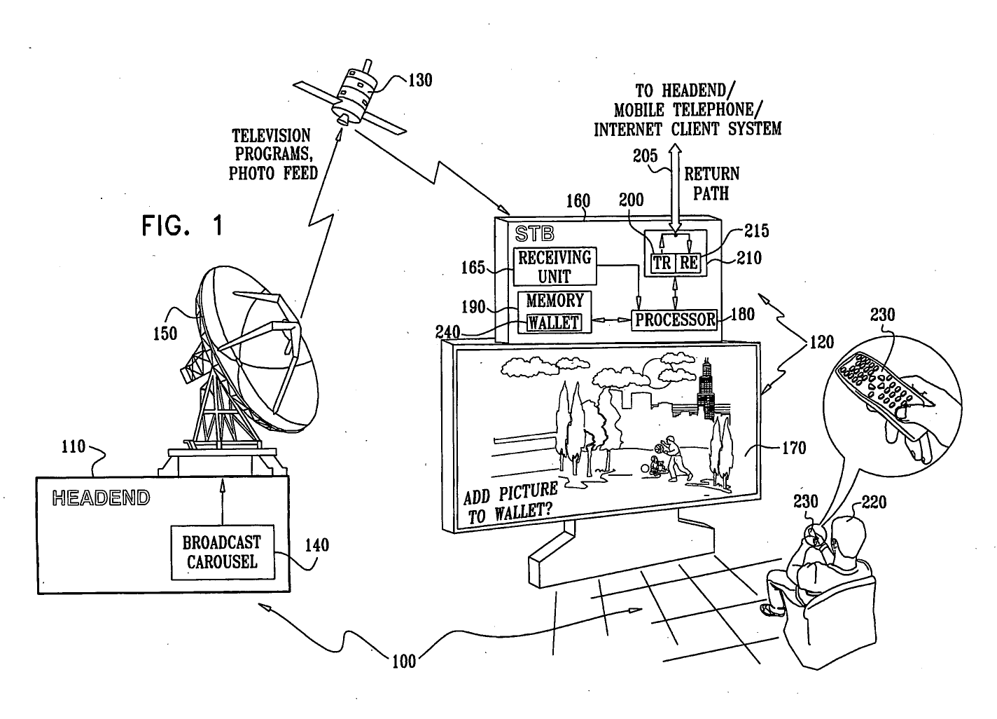

Reference is now made to FIG. 1, which is a simplified partly pictorial, partly block diagram illustration of a preferred implementation of an interactive television system 100 for providing and handling still video pictures, the interactive television system 100 being constructed and operative in accordance with a preferred embodiment of the present invention.

In the system 100, a headend 110 preferably transmits or otherwise delivers to a user unit 120 or to a plurality of user units 120 television programs and at least one photo feed comprising a plurality of still video pictures (stills). The plurality of still video pictures may preferably be arranged as a slideshow.

By way of example, which is not meant to be limiting, the headend 110 is shown in FIG. 1 transmitting television programs and a photo feed via a satellite 130. Alternatively, the headend 110 may transmit the television programs and the photo feed via at least one of the following: a cable based communication network; a conventional terrestrial broadcast television network; a telephony based communication network; a telephony based television delivery network; a mobile-telephony based television delivery network; an Internet Protocol (IP) based television delivery network; and a computer based communication network. Persons skilled in the art will appreciate that any appropriate transmission or delivery technology may be used.

One non-limiting example of an appropriate telephony or IP based television broadcast network is the Synamedia™ system, commercially available from NDS Limited, One Heathrow Boulevard, 286 Bath Road, West Drayton, Middlesex UB7 0DQ, United Kingdom.

The television programs transmitted by the headend 110 preferably include at least one of the following: pay and/or non-pay television programs; multimedia information; audio programs; data; games; and information from computer based networks such as the Internet.

Preferably, the headend 110 uses conventional transmission equipment (not shown) for transmitting the television programs to the user units 120, and a broadcast carousel 140 for transmitting the photo feed to the user units 120. The conventional transmission equipment and the broadcast carousel 140 preferably share an antenna 150 for transmitting the television programs and the photo feed to the user units 120 via the satellite 130.

For simplicity of depiction and description, and without limiting the generality of the foregoing, only one user unit 120 is illustrated in FIG. 1 and referred to below. The user unit 120 preferably includes a set-top box (STB) 160, and a display 170. The STB 160 preferably receives and processes the television programs and the photo feed transmitted from the headend 110. By way of a non-limiting example, the STB 160 receives the television programs and the photo feed via a user-premises antenna (not shown).

Preferably, the STB 160 uses a receiving unit 165 which comprises conventional receiving and decoding circuitry (not shown) for receiving and processing the television programs and the photo feed so as to provide the television programs and still video pictures comprised in the photo feed in a form suitable for rendering on the display 170. Preferably, the receiving unit 165 displays the still video pictures on the display 170 sequentially.

The display 170 is operatively associated with the STB 160 and is operative to display the television programs and the still video pictures received and processed at the STB 160. The display 170 may comprise any appropriate display such as a television or a computer monitor comprising speakers.

Preferably, in addition to the receiving unit 165, the STB 160 comprises the following units: a processor 180; a memory 190; and a transmitter 200 which transmits information via a return path. The transmitter 200 may transmit the information via the return path to at least one of the following: the headend 110; a mobile telephone (not shown); and an Internet client system (not shown).

The return path may, for example, be provided as a telephone link or as a mobile telephone link, in which case the transmitter 200 comprises a telephone transmitter. Since telephone links are typically two-way links, a telephone link 205 over which the return path is preferably provided also enables the STB 160 to receive information via the telephone link 205. In such a case, which is shown in FIG. 1, the STB 160 preferably includes a modem 210, and the transmitter 200 is preferably comprised in the modem 210. The modem 210 also preferably includes a receiver 215 which enables reception of information via the two-way telephone link 205. The modem 210 is preferably operatively associated with the processor 180 and controlled by the processor 180 for transmitting information via the transmitter 200 and for receiving information via the receiver 215.

It is appreciated that, in a cable television implementation in which the STB 160 comprises an STB of a cable television system, a return path may alternatively be provided via a conventional always-on cable television back channel (not shown) in which case the transmitter 200 preferably comprises a cable transmitter (not shown) which is capable of transmitting information via the back channel.

Preferably, operation of the STB 160 is controlled by a user 220 via, for example, a conventional remote control (RC) 230.

In operation, the headend 110 may use, by way of a non-limiting example, for creating a multi-slide photo feed application: Value@TV™ infrastructure and applications which are commercially available from NDS Limited, One Heathrow Boulevard, 286 Bath Road, West Drayton, Middlesex UB7 0DQ, United Kingdom; or OpenTV Streamer™ software which is commercially available from OpenTV, Inc. of San Francisco, Calif., USA. The multi-slide photo feed application may include JPEG (Joint Photographic Experts Group) stills and/or MPEG (MPEG—Motion Picture Experts Group) stills. The MPEG stills preferably include MPEG-2 stills and/or MPEG-4 stills. Preferably, the JPEG and/or MPEG stills are repeatedly and cyclically transmitted by the broadcast carousel 140 as a steady stream of still video pictures thus creating the photo feed.

The photo feed may, for example, be provided at a rate of three pictures per minute. Such a photo feed is economical in terms of bandwidth and may require, for example, about 32 kilobits per second (Kbit/sec) of bandwidth based on an estimate of 40 kilobyte (KByte) images and approximately 50% overhead, where the overhead may include, by way of a non-limiting example, MPEG headers and directory modules.

It is appreciated that a typical television (TV) channel having medium quality takes 2 megabits per second (Mbit/sec) or more. If such a TV channel is allocated for delivering photo feeds, the TV channel may accommodate 64 different interactive photo feeds. Alternatively, if a TV channel which is typically used for delivering interactive games and takes 600 Kbit/sec is allocated for delivering photo feeds, 16 different photo feeds may be accommodated. It is appreciated that a single photo feed may practically accommodate an unlimited number of pictures.

Preferably, the photo feed, as well as television programs transmitted by the headend 110, are received by the receiving unit 165. The photo feed application, as well as the television programs, may be associated with television channels so that the user 220 may access the photo feed application or the television programs through channel selection. Upon selecting the photo feed application, for example by using the RC 230 to tune to a channel which comprises the photo feed, the STB 160 may use, by way of a non-limiting example, middleware of the Value@TV™ infrastructure and applications, or middleware of OpenTV, Inc. to process the photo feed and to enable interactive operations on the photo feed and sequential presentation of the still video pictures of the photo feed on the display 170.

Preferably, the still video pictures are sequentially displayed on the display 170 starting from a current video picture in a picture display queue. The user 220 may then simply let the still video pictures pass by and occasionally operate the RC 230 for selecting still video pictures from the photo feed and for activating interactive features of the photo feed application. Preferably, selection, by the user 220, of still video pictures from the photo feed and activation, by the user 220, of the interactive features of the photo feed application are enabled and performed by the processor 180.

In accordance with a preferred embodiment of the present invention, one of the interactive features of the photo feed application is a “wallet” feature which enables the user 220 to store at least one still video picture selected by the user 220 in the memory 190 and to produce a wallet 240 of such pictures. The wallet 240 is preferably defined, produced and managed by the processor 180 according to instructions and selections made by the user 220. The wallet 240 is basically an inventory of images stored from the steady stream of still video pictures and indicated, typically, by thumbnails. By accessing the wallet 240 the user 220 can view, delete and forward images of the user's choice. Preferably, the wallet 240 may be produced as long as the channel which comprises the photo feed is not changed.

Such a wallet feature typically allows the user 220 to store a limited number of still video pictures and simulates a wallet with photos that people typically carry. It is appreciated that storage of the at least one selected still video picture and production of the wallet 240 may be associated with a payment and may be enabled in response to receipt of an indication of agreement by the user 220 to make the payment. In such a case, the user 220 is preferably prompted to provide an indication of agreement to pay for producing the wallet 240 and for storing the at least one selected still video picture, and upon the user 220 providing the indication of agreement to make such payment, the processor 180 produces the wallet 240 and stores the at least one selected still video picture in the wallet 240.

Association of the wallet feature with payments may be treated as a pay service which may be provided to the user 220 in addition to a conventional pay television service. Preferably, accounting operations associated with such a pay service, including operations related to payments for production of the wallet 240 and for storage of selected still video pictures in the wallet 240, may, for example, be handled as described in U.S. Pat. Nos. 5,539,450 and 5,592,212 to Handelman, the disclosures of which are incorporated herein by reference.

The number of still video pictures that can be stored in the wallet 240 is typically limited by storage capacity of the memory 190 and by application design considerations. For example, the wallet 240 may enable storage of 10 photos having a total capacity of 400 KByte. The user 220 may easily add to the wallet 240 a still video picture that “flies by”, for example, by pressing on a single key, such as a color key (not shown) of the RC 230, or by choosing an “add to wallet” option as shown in FIG. 1. Such an option may preferably be presented in a photo feed application menu (not shown) which may be displayed on the display 170, for example as an on-screen overlay as shown in FIG. 1, and the user 220 may choose such an option, for example, by pressing on another key (not shown) of the RC 230. It is appreciated that the wallet 240 may typically be inspected by the user 220.

Further in accordance with a preferred embodiment of the present invention, another interactive feature of the photo feed application enables the user 220 to transmit pictures that are stored in the wallet 240 or to transmit the entire wallet content. In such a case, when the user 220 selects, using, for example, the RC 230, an option in the photo feed application menu to transmit pictures or the entire wallet content, the processor 180 preferably retrieves the pictures or the entire wallet content from the memory 190 and provides the pictures or the entire wallet content to the transmitter 200. The transmitter 200 preferably transmits the pictures or the entire wallet content via the return path 205.

The user 220 may, for example, choose to transmit the pictures or the entire wallet content to another device that the user 220 uses, such as a mobile telephone. In such a case, the user 220 preferably enters, using the RC 230, an identification of the device and, based on the identification of the device, the processor 180 preferably instructs the transmitter 200 to transmit the pictures or the entire wallet content to the device.

Alternatively, the user 220 may choose an option which enables transmission and forwarding of the pictures or the entire wallet content to another user, such as a remote user (not shown). In such a case, the user 220 may enter, using the RC 230, an identification of a target unit to which to forward the pictures or the entire wallet content, where the target unit comprises, for example, at least one of the following: an STB of the remote user; a mobile telephone of the remote user; and an Internet client system accessible by the remote user. Based on the identification of the target unit, the processor 180 preferably instructs the transmitter 200 to transmit the pictures or the entire wallet content to the corresponding target unit via which the remote user may accept the pictures or the entire wallet content and view the pictures or the entire wallet content. Such an option enables a first user (the user 220) to forward pictures to a second user (the remote user) thus increasing exposure to and interest in the still video pictures comprised in the photo feed.

Preferably, the pictures or the entire wallet content are transmitted as a multimedia messaging service (MMS) message. Alternatively, the pictures or the entire wallet content may be transmitted as an attachment in an electronic-mail (e-mail) communication, which e-mail communication may, for example, be handled as described in U.S. Pat. Nos. 5,414,773, 5,715,315 and 6,634,028 to Handelman, the disclosures of which are incorporated herein by reference.

Further preferably, the pictures or the entire wallet content may be transmitted for a fee, in which case the pictures or the entire wallet content are preferably transmitted in response to receipt of an indication of agreement by the user 220 to pay for transmission of the pictures or the entire wallet content.

It is appreciated that, in a case where the pictures or the entire wallet content are to be forwarded to the remote user, actual payment for forwarding the pictures or the entire wallet content, as well as an indication of agreement to pay for the forwarding, may be provided either by the user 220 or by the remote user, and the forwarding of the pictures or the entire wallet content is preferably effected in response to receipt of such an indication.

It is further appreciated that transmission of the pictures or the entire wallet content to another device that the user 220 uses or to another user, as well as the storage of the at least one selected still video picture and the production of the wallet 240, may alternatively be enabled for a subscription fee, such as a monthly fee. Further alternatively, payment for the transmission of the pictures or the entire wallet content may be per session, per a time period such as per minute, or as a fixed price for a predefined period of time. In any such case, respective payments may be handled within the pay service and as described in U.S. Pat. Nos. 5,539,450 and 5,592,212 to Handelman, the disclosures of which are incorporated herein by reference.

Preferably, the wallet content is lost when the user 220 leaves the photo feed application and thus the user 220 may have a strong motivation to transmit pictures or the entire wallet content to the mobile telephone used by the user 220 or to a device enabling permanent storage of the pictures or the entire wallet content. Alternatively, the wallet content may be retained if the memory 190 comprises a non-volatile storage element (not shown) having sufficient storage capacity for storing the wallet content in which case the wallet content is preferably stored in the non-volatile storage element.

It is appreciated that usage of the wallet 240 may be extended with a web-interface that allows the user 220 to access the wallet 240 from a personal computer (PC) (not shown) or from another computing device such as a personal digital assistant (PDA) device (not shown). In such a case, the user 220 may use the web-interface for storing the wallet content in a “web-wallet” in a large-capacity memory (not shown) comprised in the PC or the PDA device. The web-wallet is similar to the wallet 240 except that the web-wallet is stored in a memory external to the STB 160, the web-wallet has a larger capacity for storing pictures than the wallet 240, and the web-wallet is accessed via a network link (not shown) in the PC or the PDA device. Since the PC and the PDA device typically have a much larger memory than the memory 190 of the STB 160, the user 220 may allocate a sufficiently large portion of the memory in the PC or the PDA device for the web-wallet in order to store in the web-wallet much more pictures than in the wallet 240.

The term “web-interface” is used throughout the present specification and claims to include a two-way network link which enables access to the World-Wide Web (WWW) and to global networks such as the Internet, and interfacing hardware and software elements that enable establishing a connection to and from the WWW and the global networks via the two-way network link.

By way of a non-limiting example, the web-interface in FIG. 1 is provided via the two-way telephone link 205, and the modem 210 and the processor 180 preferably comprise interfacing hardware and software elements that enable to establish a connection to and from the WWW and the global networks via the telephone link 205.

It is appreciated that in a cable television implementation in which the return path is provided via a cable television back channel, the web-interface may be provided via a separate link and separate interfacing elements (not shown).

It is further appreciated that the user 220 may also be charged for storing pictures in the web-wallet, in which case respective payments may be handled within the pay service and as described in U.S. Pat. Nos. 5,539,450 and 5,592,212 to Handelman, the disclosures of which are incorporated herein by reference.

In a case where the headend 110 provides a plurality of photo feeds, the user 220 may browse through the plurality of photo feeds and select one of the photo feeds for viewing as well as switch from one photo feed to another at the user's discretion. The photo feeds may be accommodated on a single channel or, alternatively, each of the plurality of photo feeds may be provided over a separate channel. It is appreciated that the photo feeds may be arranged according to various themes, such as nature, art, historical figures, landscapes, etc. Alternatively, the photo feeds may include still video pictures comprising a mixture of themes.

Preferably, the user 220 may use the pictures stored in the wallet 240 for various applications. For example, the pictures may be used as constantly changing themed “wall-papers” on a plasma television or on an LCD or other appropriate television. In such a case, the user 220 may preferably enter, for example using the RC 230, an input determining a user-defined interval between pictures thus instructing the processor 180 to switch from one wallet-stored picture to another after each such interval.

Alternatively, the pictures stored in the wallet 240 may be used as photo albums that are browsed and viewed with family members and friends. Upon uploading the pictures to a web-wallet, the pictures may, for example, be shared with the family members and friends, which family members and friends may access the web-wallet through network links in their own PCs and PDA devices (not shown).

In a case where there are a few STBs and displays at a site of the user 220, a different photo feed may, for example, be selected and displayed in each room at the user's site.

The photo feed application menu may preferably include the following interactive features, for example on a main menu screen (not shown):
“Hold current photo”;
“Add picture to wallet”; and
“Change photo feed”.

Additionally, the photo feed application menu may include the following interactive features on a wallet menu screen (not shown):
“E-mail wallet photo”;
“MMS wallet photo”;
“Clear wallet”;
“Next photo”;
“Previous photo”; and
“Go to feed”.

Preferably, at least some photo feeds may be associated with advertisements. In such a case, a photo feed associated with advertisements preferably comprises at least one targeted advertisement for at least one of the following: the user 220; and the remote user. For example, every one of a predetermined number of still video pictures in the photo feed, such as every fifth picture, may comprise an advertisement which is targeted for at least one of the following: the user 220; and the remote user.

It is appreciated that various sub-combinations of the system 100 may comprise alternative preferred embodiments of the present invention. For example, and without limiting the generality of the foregoing, the STB 160 may comprise an alternative preferred embodiment of the present invention.

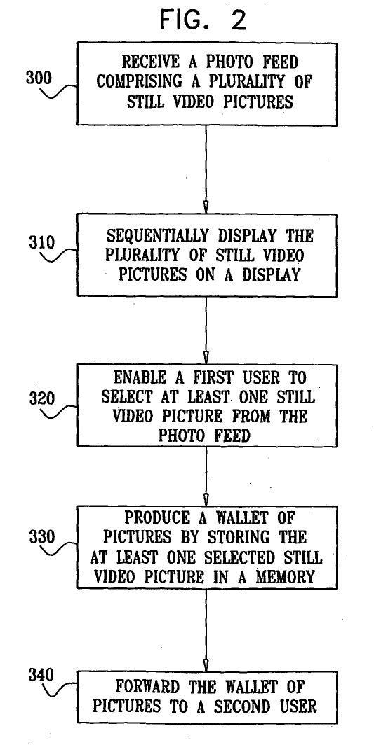

Reference is now made to FIG. 2, which is a simplified flowchart illustration of a preferred method of operation of the STB 160 in the system 100 of FIG. 1.

Preferably, the STB 160 receives (step 300), via a broadcast carousel, a photo feed comprising a plurality of still video pictures. The plurality of still video pictures are preferably sequentially displayed (step 310) on a display. Preferably, a first user is enabled (step 320) to select at least one still video picture from the photo feed, and a wallet of pictures is preferably produced (step 330) by storing the at least one selected still video picture, selected by the first user, in a memory. The wallet of pictures is then preferably forwarded (step 340) to a second user in accordance with an instruction of the first user and an identification, by the first user, of a target unit usable by the second user.

It is appreciated that software components of the present invention may, if desired, be implemented in ROM (read only memory) form. The software components may, generally, be implemented in hardware, if desired, using conventional techniques.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the claims which follow:

1-20. (canceled)

21: An interactive television method comprising:
receiving, via a broadcast carousel, a photo feed comprising a plurality of still video pictures;
sequentially displaying the plurality of still video pictures on a display;
enabling a first user to select at least one still video picture from the photo feed;
producing a wallet of pictures by storing the at least one selected still video picture, selected by the first user, in a memory; and
forwarding the wallet of pictures to a second user.

22: The method according to claim 21 and wherein the sequentially displaying comprises displaying the plurality of still video pictures starting from a current video picture in a display queue.

23: The method according to claim 21 and wherein the producing comprises producing the wallet of pictures in response to receipt of an indication of agreement to pay for the producing.

24: The method according to claim 21 and wherein the forwarding comprises forwarding the wallet of pictures in response to receipt of an indication of agreement to pay for the forwarding by one of the following: the first user; and the second user.

25: The method according to claim 21 and wherein the photo feed comprises at least one targeted advertisement for at least one of the following: the first user; and the second user.

26: The method according to claim 21 and wherein every one of a predetermined number of still video pictures in the photo feed comprises an advertisement.

27: The method according to claim 26 and wherein the advertisement is targeted for at least one of the following: the first user; and the second user.

28: The method according to claim 21 and also comprising using a web-interface for storing the wallet content in a large-capacity external memory.

29: The method according to claim 28 and wherein the large-capacity external memory comprises a web-wallet.

30: The method according to claim 21 and wherein the receiving comprises tuning to a channel comprising the photo feed, and the producing comprises producing the wallet of pictures for as long as the channel is not changed.

31: A Set-top Box (STB) in an interactive television system, the STB comprising:
a receiving unit receiving, via a broadcast carousel, a photo feed comprising a plurality of still video pictures, and sequentially displaying the plurality of still video pictures on a display;
a memory;
a processor enabling a first user to select at least one still video picture from the photo feed, and producing a wallet of pictures by storing the at least one selected still video picture, selected by the first user, in the memory; and
a transmitting unit forwarding the wallet of pictures to a second user.

32: The STB according to claim 31 and wherein the receiving unit sequentially displays the plurality of still video pictures on the display starting from a current video picture in a display queue.

33: The STB according to claim 31 and wherein the processor produces the wallet of pictures in response to receipt of an indication of agreement to pay for the producing.

34: The STB according to claim 31 and wherein the transmitting unit forwards the wallet of pictures in response to receipt of an indication of agreement to pay for the forwarding by one of the following: the first user; and the second user.

35: The STB according to claim 31 and wherein the photo feed comprises at least one targeted advertisement for at least one of the following: the first user; and the second user.

36: The STB according to claim 31 and wherein every one of a predetermined number of still video pictures in the photo feed comprises an advertisement.

37: The STB according to claim 36 and wherein the advertisement is targeted for at least one of the following: the first user; and the second user.

38: The STB according to claim 31 and also comprising a web-interface for enabling storage of the wallet content in a large-capacity external memory.

39: The STB according to claim 38 and wherein the large-capacity external memory comprises a web-wallet.

40: The STB according to claim 31 and wherein the receiving unit also tunes to a channel comprising the photo feed, and the processor produces the wallet of pictures for as long as the channel is not changed.
